(19) United States
(12) Patent Application Publication
(10) Pub. No.: US 2025/0007823 A1
(43) Pub. Date: Jan. 2, 2025

(54) TRAFFIC IDENTIFICATION APPARATUS, SWITCH, ROUTER, TRAFFIC IDENTIFICATION METHOD, AND TRAFFIC IDENTIFICATION PROGRAM

(71) Applicant: Nippon Telegraph and Telephone Corporation, Tokyo (JP)

(72) Inventors: Satoshi NAKATSUKASA, Musashino-shi, Tokyo (JP); Yuki TAKEI, Musashino-shi, Tokyo (JP); Masato NISHIGUCHI, Musashino-shi, Tokyo (JP); Hiroyuki ONISHI, Musashino-shi, Tokyo (JP)

(21) Appl. No.: 18/291,275

(22) PCT Filed: Aug. 18, 2021
(86) PCT No.: PCT/JP2021/030269

§ 371 Date: Jan. 23, 2024

(51) Int. Cl. H04L 45/00; H04L 45/302; H04L 45/745

(52) U.S. Cl. CPC H04L 45/38; H04L 45/306; H04L 45/745

(57) ABSTRACT

A traffic identification device includes a first acquisition module, a first setting module, a second acquisition module, and a second setting module. The first acquisition module acquires first packet identification information for identifying a packet with a first granularity and a network identifier associated with the first packet identification information. The first setting module sets the first packet identification information and the network identifier to a switch connected to a router for receiving packets from a user base such that the switch assigns the network identifier to a packet matching the first packet identification information. The second acquisition module acquires second packet identification information for identifying a packet transmitted from the user base with a second granularity coarser than the first granularity. The second setting module sets the second packet identification information to the router.

### TECHNICAL FIELD

The present disclosure relates to a traffic identification device, a switch, a router, a traffic identification method, and a traffic identification program.

### BACKGROUND ART

Applications running on networks have diversified in recent years. The diversification of applications has increased the expectation for application-aware networking. With such an expectation, network operators have studied providing higher quality network services that provides a high added value. For example, network operators can provide higher quality network services by performing priority control or path selection on packets transmitted by users.

For priority control and path selection, there is a technique for identifying packets at a fine application level by using, for example, dedicated hardware products such as deep packet inspection (DPI).

### CITATION LIST

### Non Patent Literature

[NPL 1] “Introduction to DPI (Deep Packet Inspection),” [online], [retrieved on Aug. 18, 2021], Internet <https://www.netone.CO.jp/knowledge-center/blog-column/knowledge-takumi_050/>

### SUMMARY OF INVENTION

### Technical Problem

However, in the above-described prior art, it is sometimes difficult to economically perform packet identification with fine granularity.

For example, dedicated hardware products such as DPI are generally expensive.

On the other hand, there is a technique for identifying packets at a fine application level by using a commercially available router. For example, a transfer mechanism for determining a packet transfer destination is introduced into a commercially available router constituting a carrier network.

In this transfer mechanism, a packet transfer destination is determined by performing filtering using an access list on the basis of a 5-tuple (transmission source address, destination address, transmission port number, reception port number, and protocol number). There is an application that can be identified using such a transfer mechanism introduced into a commercially available router. When a commercially available router is used to identify an application, an entry is registered in order to identify header information such as a transmission source address and a transmission control protocol (TCP) port number.

However, the number of entries that can be registered in a general commercially available router is about several thousand. On the other hand, the number of header information patterns used by applications may be several thousand or more. In order to control a network with a finer granularity for each user, the number of entries which are registered is insufficient simply with a commercially available router.

Therefore, the present disclosure proposes a traffic identification device, a switch, a router, a traffic identification method, and a traffic identification program capable of economically performing packet identification with fine granularity.

### Solution to Problem

In one aspect of the present disclosure, a traffic identification device includes: a first acquisition module configured to acquire first packet identification information for identifying a packet with a first granularity and a network identifier associated with the first packet identification information; a first setting module configured to set the first packet identification information and the network identifier to a switch connected to a router for receiving packets from a user base such that the switch assigns the network identifier to a packet matching the first packet identification information; a second acquisition module configured to acquire second packet identification information for identifying a packet transmitted from the user base with a second granularity coarser than the first granularity; and a second setting module configured to set the second packet identification information to the router such that the router transfers a packet matching the second packet identification information to the switch.

### Advantageous Effects of Invention

The traffic identification device according to one or more embodiments of the present disclosure can economically perform packet identification with fine granularity.

### BRIEF DESCRIPTION OF DRAWINGS

FIG. 1 shows a comparison between an example of current network control and an example of network control according to the present disclosure.

FIG. 2 shows an example of entry identification in a commercially available router.

FIG. 3 is a block diagram showing an example of an environment for traffic identification.

FIG. 4 is a block diagram showing an example of a configuration of a traffic identification device according to the present disclosure.

FIG. 5 is a block diagram showing an example of a configuration of a switch according to the present disclosure.

FIG. 6 is a block diagram showing an example of a configuration of a router according to the present disclosure.

FIG. 7 shows an example of traffic identification according to the present disclosure.

FIG. 8 shows an example of an MPLS VPN network according to the present disclosure.

FIG. 9 shows an example of traffic identification management according to the present disclosure.

FIG. 10 shows an example of setting service identification information according to the present disclosure.

FIG. 11 shows an example of setting user identification information according to the present disclosure.

FIG. 12 is a flowchart showing an example of processing for identifying traffic.

FIG. 13 shows a hardware configuration of a computer.

### DESCRIPTION OF EMBODIMENTS

A plurality of embodiments will be described in detail below with reference to the drawings. Note that the present invention is not limited to the plurality of embodiments. A plurality of features of various embodiments may be combined in various ways, provided that these plurality of features are not mutually contradictory. The same components are denoted by the same reference numerals, and redundant description will be omitted.

### 1. Introduction

In a large-scale network such as a carrier network, a commercially available provider edge (PE) router performs identification of communication paths of a large amount of packets and identification of priority of packets.

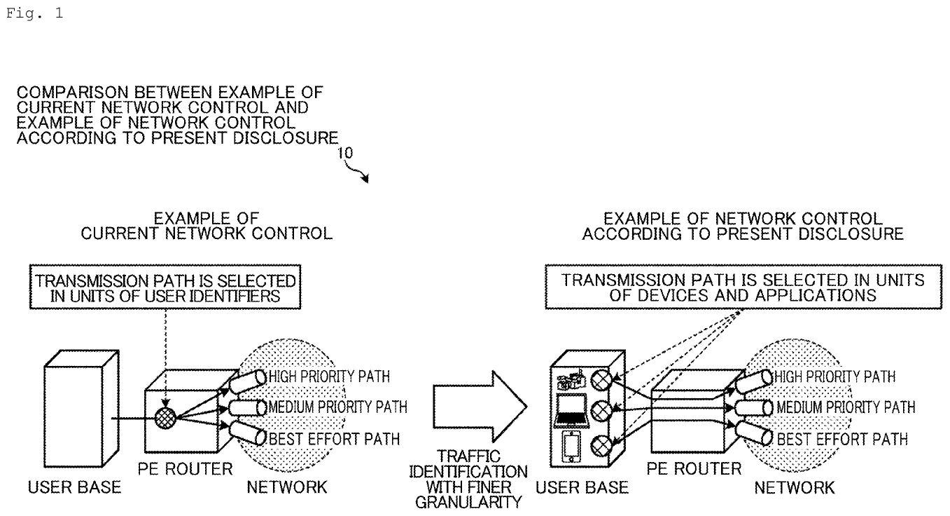

FIG. 1 shows a comparison 10 which is a comparison between an example of current network control and an example of network control according to the present disclosure. The comparison 10 includes an example of current network control and an example of network control according to the present disclosure.

In the example of current network control, a transmission path is selected in units of user identifiers. For example, a packet is transmitted from a user base to the PE router. A network includes a plurality of paths such as a high priority path, a medium priority path, and a best effort path. The PE router selects a path of a packet on the basis of a user identifier of the packet.

On the other hand, in the example of network control according to the present disclosure, traffic identification with finer granularity is performed. In the example of network control according to the present disclosure, a transmission path is selected in units of devices and applications. A user base includes, for example, a plurality of devices such as a camera, a laptop computer, and a smartphone. Further, various applications may be installed in a plurality of devices. The PE router selects a path of a packet on the basis of information identifying such a device or application.

In order to perform network control, for example, a commercially available router is used as the PE router. However, it may be difficult to apply a commercially available router to network control of a large-scale network.

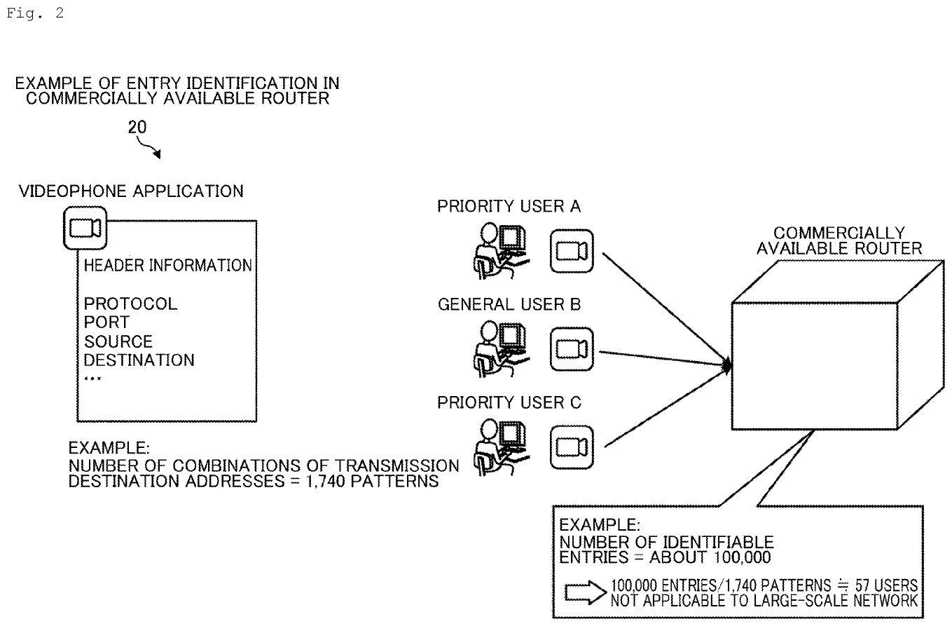

FIG. 2 shows entry identification 20 which is an example of entry identification in a commercially available router. As shown in FIG. 2, a packet of an application such as a videophone application has header information. For example, the header information includes a 5-tuple (for example, a combination of a user address and a transmission destination address of an application, and the like).

In order to identify header information such as a transmission source address and a TCP port number, entries are registered, but the number of entries is about several thousand.

On the other hand, the number of header information patterns used by applications may be several thousand or more. In the example shown in FIG. 2, the number of patterns for identifying traffic of the videophone application is the number of combinations of transmission destination addresses. The number of combinations is 1,740 patterns.

In the example shown in FIG. 2, a commercially available router identifies a plurality of users such as a priority user A, a general user B, and a priority user C. In a commercially available router, for example, the number of identifiable entries is about 100,000. However, since the number of combinations of transmission destination addresses is 1,740 patterns, the commercially available router shown in FIG. 2 can identify only 57 users. If only commercially available routers are used to perform network control with fine granularity, the number of entries which are registered is insufficient.

In order to solve the above problem, a traffic identification device according to one or more embodiments of the present disclosure performs one or a plurality of types of traffic identification processing described below.

### 2. Environment for Traffic Identification

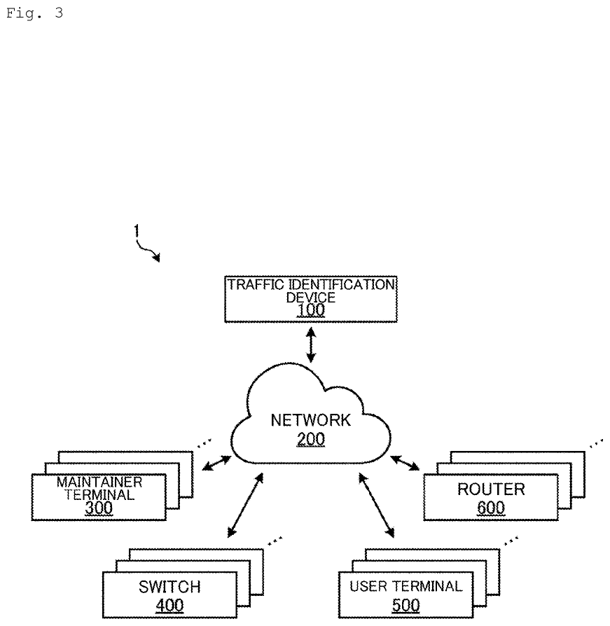

First, an environment for traffic identification according to the present disclosure will be described with reference to FIG. 3.

FIG. 3 is a block diagram of an environment 1 which is an example of an environment for traffic identification. As shown in FIG. 3, the environment 1 includes a traffic identification device 100, a network 200, a maintainer terminal 300, a switch 400, a user terminal 500, and a router 600.

The traffic identification device 100 is a device for performing one or a plurality of types of traffic identification processing. The one or plurality of types of traffic identification processing include processing of setting the switch 400 and the router 600. Traffic identification processing is performed to economically identify a service to which a packet corresponds with a fine granularity. An example of traffic identification processing according to the present disclosure will be described in section 6.

The traffic identification device 100 is a data processing device such as a server. An example of the configuration of the traffic identification device 100 will be described in section 4.

The network 200 is, for example, a network such as a local area network (LAN), a wide area network (WAN), or the Internet. The network 200 connects the traffic identification device 100, the maintainer terminal 300, the switch 400, the user terminal 500 and the router 600.

The maintainer terminal 300 is a data processing device such as a client device. For example, the maintainer terminal 300 is a console terminal used by a network maintainer.

The switch 400 is a data processing device such as a switch. For example, the switch 400 is a layer (L) 3 switch.

The user terminal 500 is a data processing device such as a client device. For example, the user terminal 500 is a device such as a laptop computer or a smartphone.

The router 600 is a data processing device such as a router. For example, the router 600 is a PE router or a core router.

### 3. Configuration of Traffic Identification Device

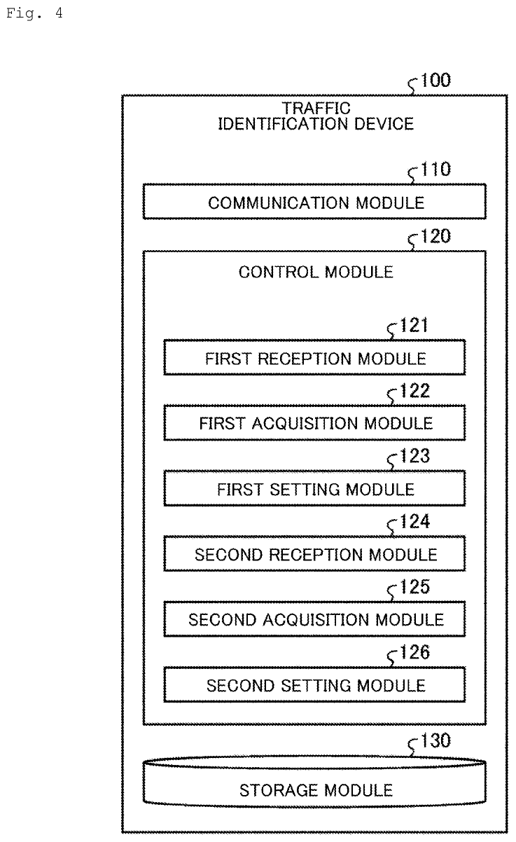

Next, an example of a configuration of the traffic identification device 100 will be described with reference to FIG. 4.

FIG. 4 is a block diagram of the traffic identification device 100 which is an example of the configuration of the traffic identification device according to the present disclosure. As shown in FIG. 4, the traffic identification device 100 includes a communication module 110, a control module 120, and a storage module 130. The traffic identification device 100 may include an input module (for example, a keyboard or a mouse) for receiving an input from a manager of the traffic identification device 100. The traffic identification device 100 may include an output module (for example, a liquid crystal display or an organic electroluminescence (EL) display) for displaying information to the manager of the traffic identification device 100.

### 3-1. Communication Module 110

The communication module 110 is realized by, for example, a network interface card (NIC). The communication module 110 is connected to the network 200 in wired or wireless manner. The communication module 110 can transmit/receive information to/from the maintainer terminal 300, the switch 400, the user terminal 500, and the router 600 via the network 200.

### 3-2. Control Module 120

The control module 120 is a controller. The control module 120 uses a random access memory (RAM) as a working area, and is implemented by one or a plurality of processors (for example, a central processing unit (CPU) and a micro-processing unit (MPU)) executing various programs stored in a storage device of the traffic identification device 100. Further, the control module 120 may be implemented by an integrated circuit such as an application specific integrated circuit (ASIC), a field-programmable gate array (FPGA), or a general purpose graphic processing unit (GPGPU).

As shown in FIG. 4, the control module 120 includes a first reception module 121, a first acquisition module 122, a first setting module 123, a second reception module 124, a second acquisition module 125, and a second setting module 126. The one or plurality of processors of the traffic identification device 100 can implement each control module by executing instructions stored in one or more memories of the traffic identification device 100. Data processing performed by each control module is an example, and each control module (for example, the first setting module 123) may perform data processing described in relation to another control module (for example, the first reception module 121).

The first reception module 121 receives packet identification information (for example, header information such as a 5-tuple) for identifying a packet with a specific granularity from the maintainer terminal 300. The first reception module 121 receives a network identifier associated with the packet identification information from the maintainer terminal 300. The first reception module 121 stores the packet identification information and the network identifier in a storage module 130.

The first acquisition module 122 acquires, from the storage module 130, packet identification information (for example, header information such as a 5-tuple) for identifying a packet with a specific granularity. Further, the first acquisition module 122 acquires a network identifier associated with the packet identification information from the storage module 130.

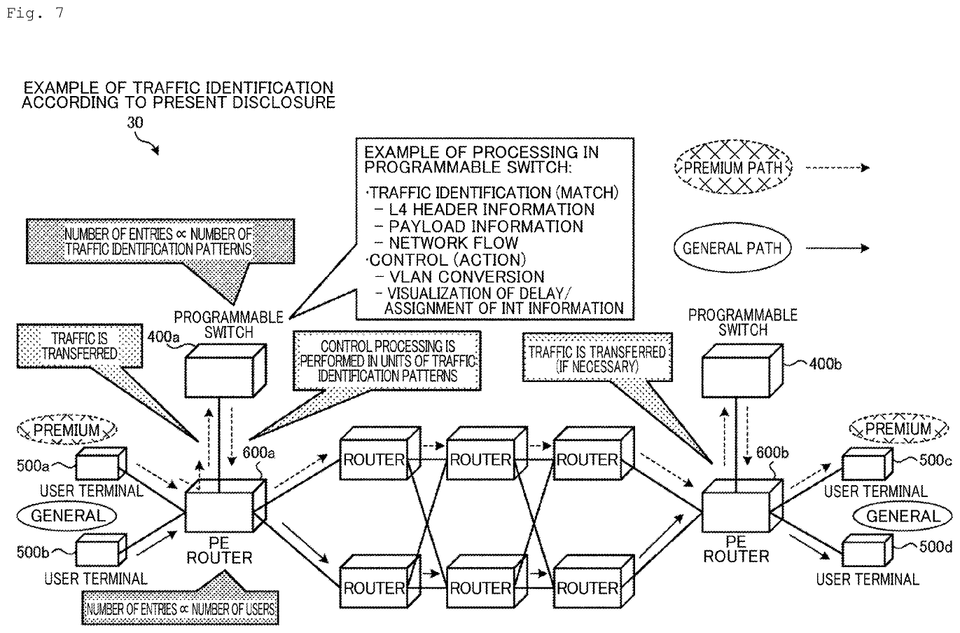

The first setting module 123 sets the packet identification information and the network identifier acquired by the first acquisition module 122 to the switch 400. This setting will be described in more detail below with reference to FIGS. 7, 8, 9, 10 and 11.

The second reception module 124 receives, from the user terminal 500, packet identification information (for example, VLAN-ID) for identifying a packet with a specific granularity. The second reception module 124 stores the packet identification information in the storage module 130.

The second acquisition module 125 acquires packet identification information (for example, a virtual LAN identifier (VLAN-ID) for identifying a packet with a specific granularity from the storage module 130.

The second setting module 126 sets the packet identification information acquired by the second acquisition module 125 to the router 600. This setting will be described in more detail below with reference to FIGS. 7, 8, 9, 10 and 11.

The storage module 130 is implemented by, for example, a semiconductor memory element such as a RAM or a flash memory, or a storage device such as a hard disk or an optical disc. The storage module 130 stores the packet identification information and the network identifier received by the first reception module 121. Further, the storage module 130 stores the packet identification information received by the second reception module 124.

### 4. Configuration of Switch

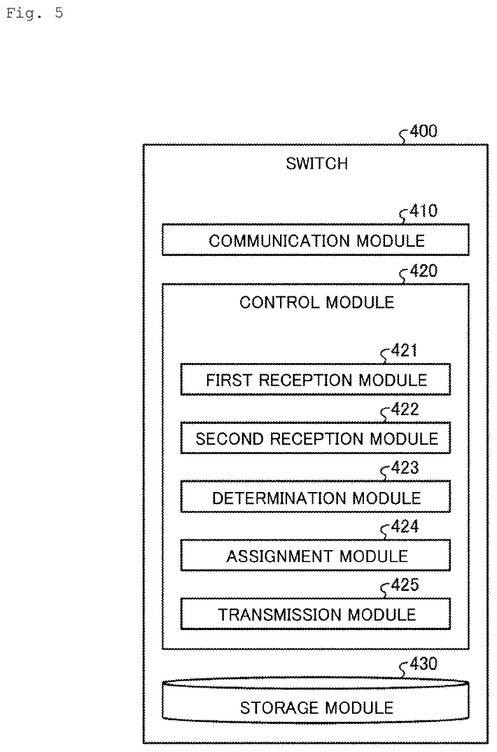

Next, an example of a configuration of the switch 400 will be described with reference to FIG. 5.

FIG. 5 is a block diagram of the switch 400 which is an example of a configuration of a switch according to the present disclosure. As shown in FIG. 5, the switch 400 includes a communication module 410, a control module 420, and a storage module 430.

The communication module 410 is connected to the router 600. The communication module 410 transmits/receives packets to/from the router 600.

The control module 420 is a controller. The control module 420 is implemented by one or a plurality of processors (for example, dedicated processors) for executing various programs stored in the storage device of the switch 400. For example, the control module 420 is implemented by an ASIC.

As shown in FIG. 5, the control module 420 includes a first reception module 421, a second reception module 422, a determination module 423, an assignment module 424, and a transmission module 425. The one or plurality of processors of the switch 400 can implement each control module by executing instructions stored in the one or plurality of memories of the traffic identification device 100.

The first reception module 421 receives packet identification information for identifying a packet. For example, the packet identification information is header information such as a 5-tuple. Further, the first reception module 421 receives a network identifier associated with the packet identification information. For example, the network identifier is a VLAN-ID.

The second reception module 422 receives a packet from the router 600.

The determination module 423 determines whether the packet matches the packet identification information.

When the determination module 423 determines that the packet matches the packet identification information, the assignment module 424 assigns the network identifier to the packet.

The transmission module 425 transmits the packet to which the network identifier has been assigned to the router 600.

The storage module 430 is implemented by a semiconductor memory element or a storage device such as a hard disk. The storage module 430 stores packet identification information and network identifiers. The storage module 430 stores settings received from the traffic identification device 100.

### 5. Configuration of Router

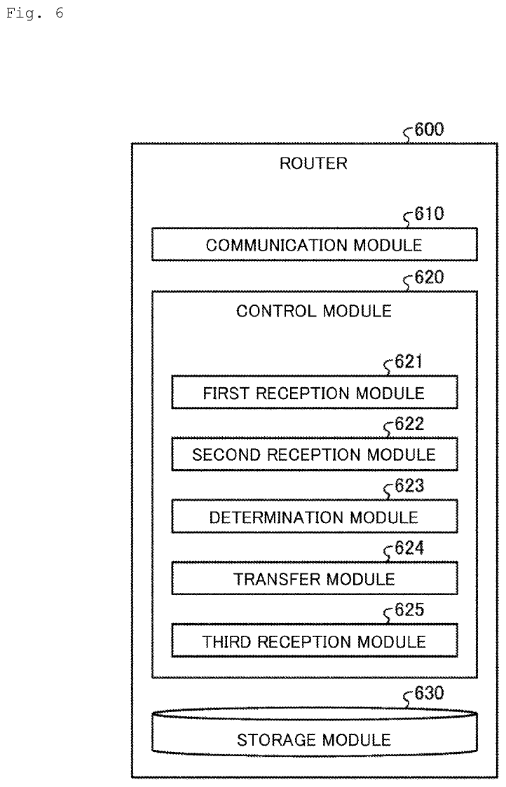

Next, an example of a configuration of the router 600 will be described with reference to FIG. 6.

FIG. 6 is a block diagram of the router 600 which is an example of a configuration of a router according to the present disclosure. As shown in FIG. 6, the router 600 includes a communication module 610, a control module 620, and a storage module 630.

The communication module 610 is connected to the switch 400. The communication module 410 transmits/receives packets to the switch 400.

The control module 620 is a controller. The control module 420 is implemented by one or a plurality of processors (for example, general-purpose processors) for executing various programs stored in the storage device of the router 600.

As shown in FIG. 6, the control module 620 includes a first reception module 621, a second reception module 622, a determination module 623, a transfer module 624, and a third reception module 625. The one or plurality of processors of the router 600 can implement each control module by executing instructions stored in one or plurality of memories of the router 600.

The first reception module 621 receives packet identification information for identifying a packet transmitted from a user base.

The second reception module 622 receives a packet from the user base.

The determination module 623 determines whether the packet matches the packet identification information.

The transfer module 624 transfers the packet to the switch 400 when the determination module 623 determines that the packet matches the packet identification information.

The third reception module 625 receives the packet from the switch 400.

The storage module 630 is implemented by a semiconductor memory element or a storage device such as a hard disk. The storage module 630 stores packet identification information. The storage module 630 stores settings received from the traffic identification device 100.

### 6. Traffic Identification Processing

Next, an example of traffic identification processing according to the present disclosure will be described with reference to FIGS. 7, 8, 9, 10 and 11.

FIG. 7 shows traffic identification 30 which is an example of traffic identification according to the present disclosure. A programmable switch 400a, a programmable switch 400b, a user terminal 500a, a user terminal 500b, a user terminal 500c, a user terminal 500d, a PE router 600a, and a PE router 600b are used for the traffic identification 30. In addition, a plurality of routers (for example, a plurality of core routers) other than the PE routers are used for the traffic identification 30. Premium paths and general paths in FIG. 7 are implemented by these apparatuses.

As shown in FIG. 7, in the PE router 600a, the number of entries is proportional to the number of users. In the programmable switch 400a, the number of entries is proportional to the number of traffic identification patterns.

In the traffic identification 30, a network in which packet identification is performed in two stages is constituted in order to perform more various types of traffic identification. The PE router 600a performs packet identification with a relatively coarse granularity. For example, packet identification is performed for each user. After packet identification, the PE router 600a transfers traffic to the programmable switch 400a.

The programmable switch 400a provided in parallel with the PE router 600a performs packet identification with a finer granularity. This can reduce the number of entries required for each device. Therefore, the configuration of the traffic identification 30 can withstand a large-scale network.

Examples of processing in the programmable switch 400a include traffic identification (match) (for example, layer (L) 4 header information, payload information, network flow, etc.), control (action) (for example, VLAN conversion, visualization of delay/assignment of INT information, etc.). The programmable switch 400a performs control processing in units of traffic identification patterns.

If necessary, the PE router 600b transfers traffic to the programmable switch 400b.

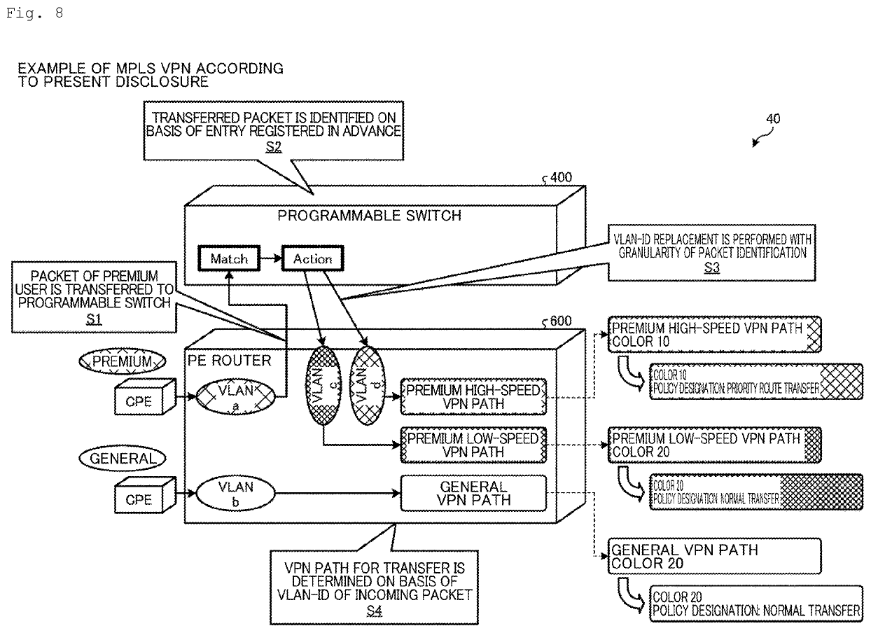

FIG. 8 shows a multi-protocol label switching virtual private network (MPLS VPN) 40 which is an example of an MPLS VPN according to the present disclosure. In the MPLS VPN 40, VLAN-ID replacement is performed. Replacement processing includes four steps.

In step S1, the router 600 (for example, a PE router) transfers a packet of a premium user to a programmable switch.

In step S2, the switch 400 (for example, a programmable switch) identifies the transferred packet on the basis of an entry registered in advance.

In step S3, the switch 400 (for example, a programmable switch) performs VLAN-ID replacement with a packet identification granularity.

In step S4, the router 600 (for example, a PE router) determines a VPN path for transfer on the basis of the VLAN-ID of an incoming packet.

When traffic does not match traffic identification conditions, the router 600 (for example, a PE router) may set this traffic to a path equivalent to a general VPN path.

As shown in FIG. 8, the router 600 (for example, a PE router) transfers a packet to the switch 400 (for example, a programmable switch) with a granularity such as a VLAN-ID of a packet of a user to be preferentially handled. For example, packet transfer is performed by static/policy base routing (PBR). After the switch 400 performs packet identification, the switch 400 converts the network identifier of the packet into an identifier (for example, VLAN-ID) that can be identified by the router 600. The router 600 determines a transmission destination of the packet.

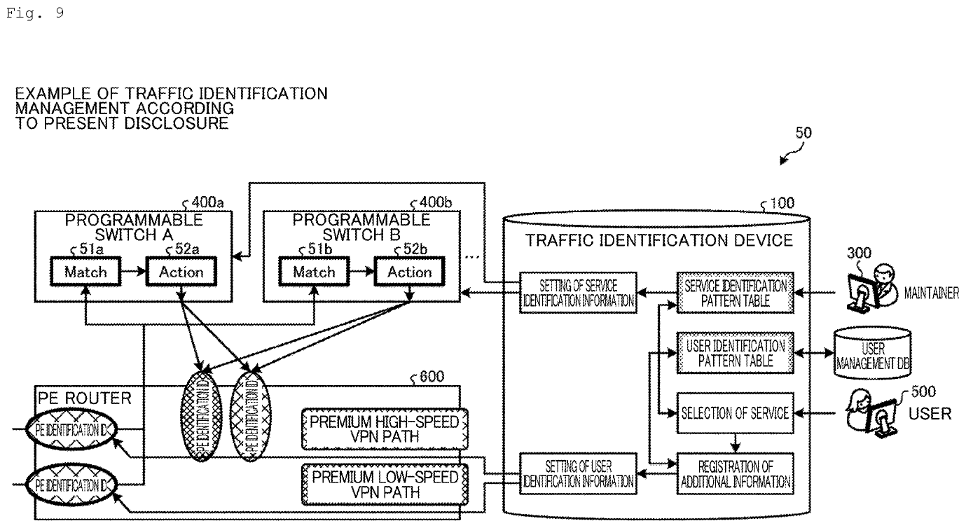

FIG. 9 shows traffic identification management 50 which is an example of traffic identification management according to the present disclosure. The traffic identification management 50 introduces a traffic identification system for implementing the traffic identification 30 shown in FIG. 7 and the MPLS VPN 40 shown in FIG. 8.

In the traffic identification management 50, a maintainer of the maintainer terminal 300 selects a pattern of a service in which packet identification is performed. Further, the maintainer selects a programmable switch in which an entry is registered. In the example shown in FIG. 9, the maintainer selects the programmable switch 400a and the programmable switch 400b.

Then, the maintainer registers the selected pattern and the programmable switches in the traffic identification device 100. The traffic identification device 100 sets conditions and actions to the programmable switches.

The traffic identification device 100 enables registration of conditions and actions to a plurality of programmable switches. Further, the traffic identification device 100 can provide a user interface that enables registration of various types of information such that the maintainer can autonomously determine a programmable switch to which a packet will be transferred. The maintainer can register various types of information such that the number of entries is scaled.

The user of the user terminal 500 accesses the traffic identification device 100 like customer control. When the user wants to join a traffic identification service, the user selects a service registered by the maintainer. In addition, the user inputs conditions that the user himself/herself wants to additionally register (for example, conditions for setting only a specific device (transmission source IP address thereof) as an identification target). The traffic identification device 100 automatically performs settings to the router 600 (for example, a PE router). In the traffic identification management 50, it is assumed that a preferred path and a PE identifier (e.g., VLAN-ID) to be pass through the preferred path are registered in advance. The storage module 130 of FIG. 4 may include a user management database (DB) of FIG. 9. Further, the storage module 130 may include a service identification pattern table or a user identification pattern table shown in FIG. 9.

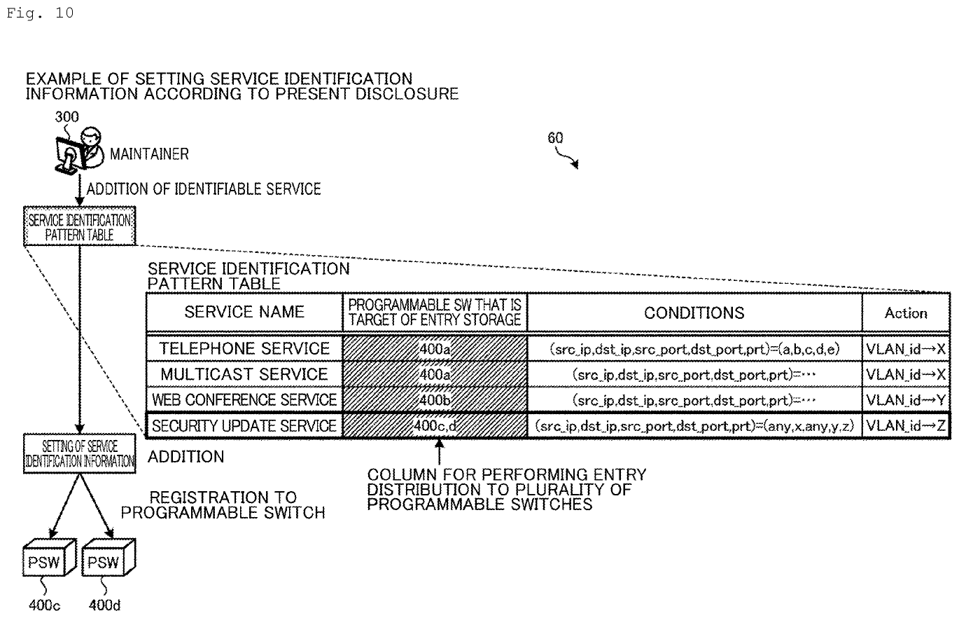

FIG. 10 shows setting 60 which is an example of setting of service identification information according to the present disclosure. As shown in FIG. 10, the maintainer of the maintainer terminal 300 adds a service identification pattern.

An identifiable service is added to the service identification pattern table. The service identification pattern table includes a service name, a programmable switch which is a target of entry storage, conditions for service identification, an action, and the like. The conditions for service identification are an example of packet identification information. The service identification information is registered in the programmable switch 400c and the programmable switch 400d. The storage module 130 of FIG. 4 may include the service identification pattern table of FIG. 10.

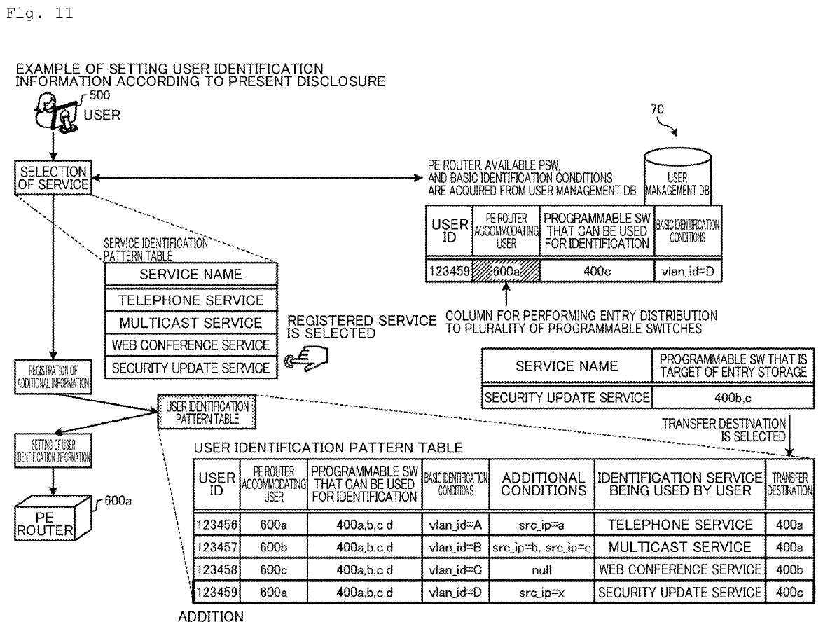

FIG. 11 shows setting 70 which is an example of setting user identification information according to the present disclosure. As shown in FIG. 11, the user of the user terminal 500 requests subscription to an identification service.

The user selects a registered service. The traffic identification device 100 acquires a PE router, an available programmable switch, and basic identification conditions from a user management DB. The user can select a transfer destination from among a plurality of packet transfer destinations. When the user wants to limit a transfer destination of a packet to a transmission source IP address of the device, the user can register identification additional information. After the transfer destination is selected, the traffic identification device 100 sets the user identification information in the PE router 600a. The storage module 130 of FIG. 4 may include the user management DB, the service identification pattern table, and the user identification pattern table of FIG. 11.

### 7. Flowchart of Traffic Identification Processing

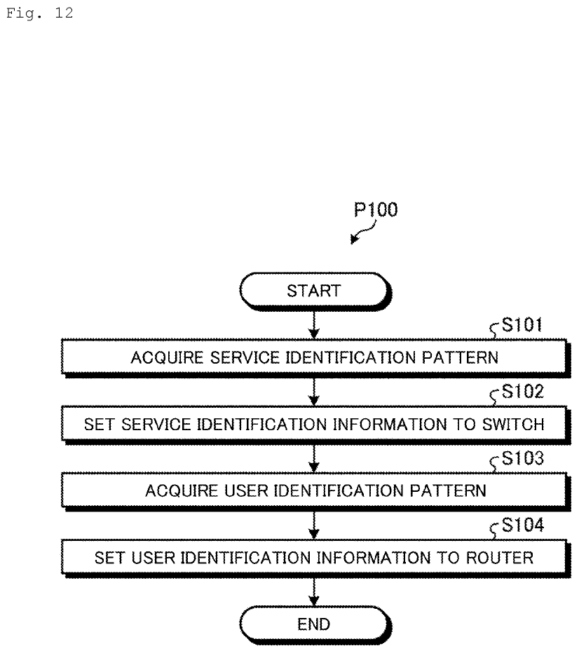

Next, a flowchart of an example of traffic identification processing according to the present disclosure will be described with reference to FIG. 12. An example of traffic identification processing includes processing for identifying traffic. The processing for identifying traffic is performed by the traffic identification device 100 shown in FIG. 3, for example.

FIG. 12 is a flowchart showing processing P100 which is an example of processing for identifying traffic.

As shown in FIG. 12, first, the first acquisition module 122 of the traffic identification device 100 acquires a service identification pattern from the storage module 130 of the traffic identification device 100 (step S101).

Subsequently, the first setting module 123 of the traffic identification device 100 sets service identification information to the switch 400 (step S102).

Subsequently, the second acquisition module 125 of the traffic identification device 100 acquires a user identification pattern from the storage module 130 (step S103).

Subsequently, the second setting module 126 of the traffic identification device 100 sets user identification information to the router 600 (step S104).

### 8. Effects

As described above, in traffic identification processing according to the present disclosure, the router 600 (for example, a PE router) performs packet identification with a coarse granularity, such as packet identification for each user. The router 600 draws only a packet of a specific condition (for example, a specific user or a priority traffic) into the switch 400 (for example, a programmable switch).

The switch 400 performs packet identification and converts a packet identifier into an identifier (e.g., VLAN-ID) that can be identified by the router. The router 600 determines a transmission destination (for example, a VPN path) on the basis of the identifier identifiable by the router.

As a result, even when a commercially available PE router is used for packet identification, the traffic identification device 100 can identify a number of packets equal to or greater than the number of entries of the router. Further, a packet can be sent to a path corresponding to packet identification. The traffic identification device 100 can provide application-aware network control with a sufficiently fine granularity.

The traffic identification device 100 can draw traffic into a programmable switch by utilizing a function of a commercially available router. For example, the traffic identification device 100 can separate a priority traffic from a general traffic by header conversion for converting an identifier of a packet into an identifier that can be identified by a commercially available router. Further, the traffic identification device 100 can transfer a priority traffic to a priority path. Therefore, existing networks can introduce traffic identification processing according to the present disclosure.

In the traffic identification processing according to the present disclosure, even when there are a plurality of programmable switches, it is possible to scale the number of entries by distributing the entries. The traffic identification device 100 can scale the number of entries capable of identifying an application.

### 9. Others

A part of processing described as processing performed automatically may be performed manually. Alternatively, all or part of processing described as processing performed manually may be performed automatically through a known method. Further, information including the procedures of processing, specific names, various types of data and parameters shown in the specification and drawings can be changed arbitrarily unless otherwise specified. For example, various types of information shown in each figure is not limited to the information shown in the figure.

The components of an illustrated device conceptually show the functions of the device. The components are not necessarily physically configured as shown in the drawings. In other words, the specific form of a distributed or integrated device is not limited to the forms of the system and device shown in the drawings. All or some of the devices may be functionally or physically distributed or integrated depending on various loads and usage situations.

### 10. Hardware Configuration

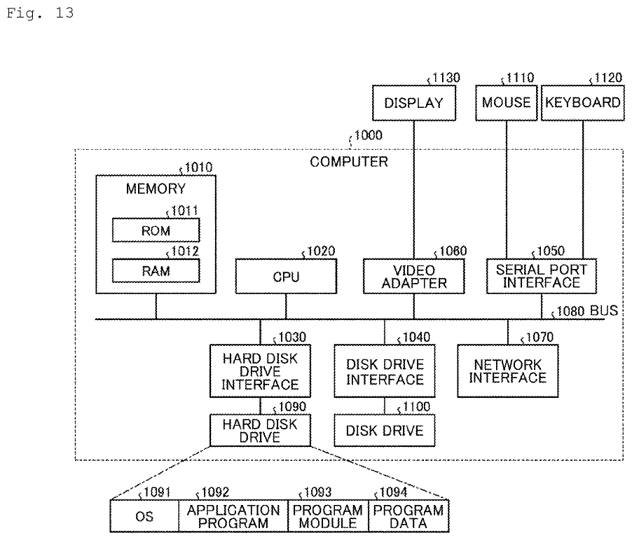

FIG. 13 is a diagram showing a computer 1000 which is an example of a hardware configuration of a computer. The system and methods described in the specification are implemented by, for example, the computer 1000 shown in FIG. 13.

FIG. 13 shows an example of a computer in which the traffic identification device 100 is implemented by executing a program. The computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These modules are connected to one another via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each type of processing of the traffic identification device 100 is implemented as the program module 1093 in which code that can be executed by the computer 1000 is described. The program module 1093 is stored in, for example, the hard disk drive 1090. For example, the program module 1093 for executing processing similar to the functional configuration in the traffic identification device 100 is stored in the hard disk drive 1090. Note that the hard disk drive 1090 may be replaced with a solid state drive (SSD).

The hard disk drive 1090 can store a traffic identification program for traffic identification processing. In addition, the traffic identification program may be created as a program product. The program product executes one or a plurality of methods, as described above, when it is executed.

Furthermore, setting data used in processing of the embodiments described above is stored in, for example, the memory 1010 or the hard disk drive 1090 as the program data 1094. In addition, the CPU 1020 reads the program module 1093 and the program data 1094 stored in the memory 1010 or the hard disk drive 1090 to the RAM 1012 and executes them as necessary.

Note that the program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and program data 1094 may be stored in another computer connected via a network (LAN, WAN, etc.). In addition, the program module 1093 and the program data 1094 may be read by the CPU 1020 from the other computer via the network interface 1070.

### 10. Summary of Embodiment

As described above, the traffic identification device 100 according to the present disclosure includes the first acquisition module 122, the first setting module 123, the second acquisition module 125, and the second setting module 126. In at least one embodiment, the first acquisition module 122 acquires first packet identification information for identifying a packet with a first granularity and a network identifier associated with the first packet identification information. In at least one embodiment, the first setting module 123 sets the first packet identification information and the network identifier to the switch 400 connected to the router 600 for receiving packets from a user base such that the switch 400 assigns the network identifier to a packet matching the first packet identification information. In at least one embodiment, the second acquisition module 125 acquires second packet identification information for identifying a packet transmitted from the user base with a second granularity coarser than the first granularity. In at least one embodiment, the second setting module 126 sets the second packet identification information to the router 600 such that the router 600 transfers a packet matching the second packet identification information to the switch 400.

In some embodiments, the first acquisition module 122 receives header information of a packet as the first packet identification information.

In some embodiments, the first acquisition module 122 acquires, as header information, at least one of a packet transmission source address, a destination address, a transmission port number, a reception port number, or a protocol number.

In some embodiments, the second acquisition module 125 receives, as the second packet identification information, a network identifier of a packet transmitted from the user base.

As described above, the switch 400 according to the present disclosure includes the first reception module 421, the second reception module 422, the determination module 423, the assignment module 424, and the transmission module 425. In at least one embodiment, the first reception module 421 receives packet identification information for identifying a packet and a network identifier associated with the packet identification information. In at least one embodiment, the second reception module 422 receives a first packet from the router 600. In at least one embodiment, the determination module 423 determines whether the first packet matches the packet identification information. In at least one embodiment, the assignment module 424 assigns the network identifier to the first packet when it is determined that the first packet matches the packet identification information. In at least one embodiment, the transmission module 425 transmits a second packet, which is a first packet to which the network identifier has been assigned, to the router 600.

As described above, the router 600 according to the present disclosure includes the first reception module 621, the second reception module 622, the determination module 623, the transfer module 624, and the third reception module 625. In at least one embodiment, the first reception module 621 receives packet identification information for identifying a packet transmitted from a user base. In at least one embodiment, the second reception module 622 receives a first packet from the user base. In at least one embodiment, the determination module 623 determines whether the first packet matches the packet identification information. In at least one embodiment, the transfer module 624 transfers the first packet to the switch 400 when it is determined that the first packet matches the packet identification information. In at least one embodiment, the third reception module 625 receives a second packet, which is a first packet to which a new network identifier has been assigned, from the switch 400.

While various embodiments have been described in the specification with reference to the drawings, these embodiments are examples and are not intended to limit the present invention to these embodiments. The features described in the specification can be realized by various methods, including various modifications and improvements based on the knowledge of the skilled person.

Further, the above-mentioned “module (-er suffix or -or suffix)” can be read as a unit, means, circuit, or the like. For example, the communication module, the control module, and the storage module include can be read as a communication unit, a control unit, and a storage unit.

### REFERENCE SIGNS LIST

1 Environment
100 Traffic identification device
110 Communication module
120 Control module
121 First reception module
122 First acquisition module
123 First setting module
124 Second reception module
125 Second acquisition module
126 Second setting module
130 Storage module
200 Network
300 Maintainer terminal
400 Switch
410 Communication module
420 Control module
421 First reception module
422 Second reception module
423 Determination module
424 Assignment module
425 Transmission module
430 Storage module
500 User terminal
600 Router
610 Communication module
620 Control module
621 First reception module
622 Second reception module
623 Determination module
624 Transfer module
625 Third reception module
630 Storage module

1. A traffic identification device comprising:
a first acquisition module, comprising one or more processors, configured to acquire first packet identification information for identifying a packet with a first granularity and a network identifier associated with the first packet identification information;
a first setting module, comprising one or more processors, configured to set the first packet identification information and the network identifier to a switch connected to a router for receiving packets from a user base such that the switch assigns the network identifier to a packet matching the first packet identification information;
a second acquisition module, comprising one or more processors, configured to acquire second packet identification information for identifying a packet transmitted from the user base with a second granularity coarser than the first granularity; and
a second setting module, comprising one or more processors, configured to set the second packet identification information to the router such that the router transfers a packet matching the second packet identification information to the switch.

2. The traffic identification device according to claim 1, wherein the first acquisition module is configured to receive header information of a packet as the first packet identification information.

3. The traffic identification device according to claim 2, wherein the first acquisition module is configured to acquire, as the header information, at least one of a packet transmission source address, a destination address, a transmission port number, a reception port number, or a protocol number.

4. The traffic identification device according to claim 1, wherein the second acquisition modules is configured to receive, as the second packet identification information, a network identifier of a packet transmitted from the user base.

5. A switch comprising:
a first reception module, implemented by one or more processors, configured to receive packet identification information for identifying a packet and a network identifier associated with the packet identification information;
a second reception module, implemented by one or more processors, configured to receive a first packet from a router;
a determination unit, implemented by one or more processors, configured to determine whether the first packet matches the packet identification information;
an assignment module, implemented by one or more processors, configured to assign the network identifier to the first packet in response to a determination that the first packet matches the packet identification information; and
a transmission module, implemented by one or more processors, configured to transmit a second packet that is the first packet to which the network identifier has been assigned to the router.

6. A router comprising:
a first reception module, implemented by one or more processors, configured to receive packet identification information for identifying a packet transmitted from a user base;
a second reception module, implemented by one or more processors, configured to receive a first packet from the user base;
a determination unit, implemented by one or more processors, configured to determine whether the first packet matches the packet identification information;
a transfer module, implemented by one or more processors, configured to transfer the first packet to a switch in response to a determination that the first packet matches the packet identification information; and
a third reception module, implemented by one or more processors, configured to receive a second packet that is the first packet to which a new network identifier has been assigned from the switch.

7. (canceled)

8. (canceled)
